(19) United States
(12) Patent Application Publication
(10) Pub. No.: US 2026/0354316 A1
(43) Pub. Date: Nov. 12, 2026

(54) CROP CULTIVATION SYSTEM FOR SHIP

(71) Applicant: Daniel PARK, Pohang-si (KR)

(72) Inventor: Daniel PARK, Pohang-si (KR)

(21) Appl. No.: 19/112,903

(22) PCT Filed: Sep. 13, 2023
(86) PCT No.: PCT/KR2023/013678

§ 371 Date: Mar. 18, 2025

(30) Foreign Application Priority Data
Sep. 19, 2022 (KR) 10-2022-0117778

(51) Int. Cl. A01G 9/24

(52) U.S. Cl. CPC A01G 9/247; A01G 9/246

(57) ABSTRACT

The present disclosure relates to a crop cultivation system for a ship that can cultivate and harvest crops inside a ship during an operation period of the ship, and more specifically, the crop cultivation system is configured to include a freshwater supply device providing freshwater needed for crop growth, a crop cultivation house installed inside the ship and providing a crop cultivation space, a crop cultivation device providing a means needed for crop sowing and growth, a nutrient solution production device producing a nutrient solution by mixing a nutrient needed for crop growth into the freshwater, a nutrient solution circulation device supplying the nutrient solution to the crop cultivation device, and a control device controlling operations of the above components.

### TECHNICAL FIELD

The present disclosure relates to a crop cultivation system for a ship that is provided in a large ship and can cultivate and harvest crops inside the ship during an operation period of the ship.

### BACKGROUND ART

In recent years, there has been an increasing demand for improvement in the quality of life, including dietary life, for sailors and crew members who spend long periods of time at sea on trading ships, deep-sea fishing vessels, aircraft carriers, or cruise ships that navigate long distances.

In the past, crops consumed during an operation period of such a ship were purchased in advance at a point of departure, refrigerated and frozen, and then stored in refrigerators for long periods of time, and as a result, the freshness of the crops deteriorated over time, and due to poor storage management, it was difficult to provide fresh vegetables or fruits to sailors, crew members, or passengers.

### DISCLOSURE

### Technical Problem

The present disclosure is directed to addressing problems such as waste of space, fuel loss due to weight increase, and decline in freshness of crops that may occur when all crops to be provided to crew members or passengers of a large ship are loaded upon the first departure.

A first objective of the present disclosure is to provide a crop cultivation system for a ship that can directly produce grains, especially vegetables, to be provided as food to crew members or passengers on a ship that operates over a long distance for a long period of time inside the ship during an operation period of the ship.

In addition, another objective of the present disclosure is to provide a smart farm system for a ship that can maximize time and space efficiency by systematically cultivating crops to be used or sold at a destination of a ship inside the ship during an operation period of the ship.

### Technical Solution

The present disclosure provides a crop cultivation system for a ship that is configured to cultivate and harvest crops inside a ship during an operation period of the ship, the crop cultivation system being configured to include: a freshwater supply device providing freshwater needed for growth of the crops; a crop cultivation house installed inside the ship and providing a crop cultivation space; a crop cultivation device installed inside the crop cultivation house and providing a means needed for sowing and growth of the crops; a nutrient solution production device producing a nutrient solution by mixing a nutrient needed for growth of the crops into the freshwater; a nutrient solution circulation device supplying the nutrient solution to the crop cultivation device and recovering the remaining nutrient solution to the nutrient solution production device; and a control device controlling operations of the components constituting the crop cultivation system.

The freshwater supply device may be configured to include a freshwater acquisition part acquiring freshwater from seawater and a freshwater supply part supplying the freshwater to the crop cultivation device.

The crop cultivation house may be configured as an air house having a crop cultivation space by injecting compressed air into a double wall fabric or an air tube made of a flexible material.

The nutrient solution production device may be configured to include a plurality of element solution cartridges each storing an element solution containing a predetermined element among elements needed for cultivating the crops and a nutrient solution production part selecting at least any one of the element solution cartridges according to a crop type and diluting the element solution stored therein together with the freshwater provided from the freshwater supply device to produce the nutrient solution.

The nutrient solution circulation device may include a nutrient solution supply unit directly spraying the nutrient solution produced by the nutrient solution production device in a mist state to roots of crops planted in the crop cultivation device and a nutrient solution recovery unit recovering the nutrient solution remaining after being absorbed into the crops in the crop cultivation device to the nutrient solution production device.

The control device may include a crop-to-be-sown selection part selecting a crop to be sown in the crop cultivation device in consideration of an operation path and an operation period of a ship, a growth period and growth conditions of a crop, and crop demand at a destination of the ship, and the crop cultivation device may include a sowing part sowing a seed based on crop-to-be-sown selection data provided by the crop-to-be-sown selection part.

### Advantageous Effects

A crop cultivation system for a ship according to the present disclosure can acquire freshwater from seawater and produce a nutrient solution during an operation period of a ship that operates over a long distance for a long period of time and can cultivate and harvest various crops using the nutrient solution.

Accordingly, it is possible to address problems such as waste of space in a ship, fuel loss due to weight increase, and decline in freshness of crops that may occur when all crops to be provided to crew members or passengers are loaded upon the departure of the ship.

In addition, the crop cultivation system for a ship according to the present disclosure can maximize time and space efficiency by systematically cultivating crops to be used or sold at a destination of a ship inside the ship during an operation period of the ship, and is also expected to lead to development of a ship specializing in smart farming in the future.

### DESCRIPTION OF DRAWINGS

FIG. 1 is a block diagram schematically illustrating a configuration of a crop cultivation system for a ship according to one embodiment of the present disclosure.

FIG. 2 is an exemplary view illustrating a state in which a crop cultivation system 10 according to the present disclosure is provided in a large ship.

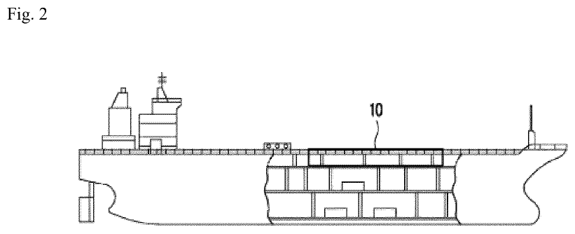

FIG. 3 is a view schematically illustrating the relationship of a freshwater supply device 100, a crop cultivation house 200, a nutrient solution production device 400, and a nutrient solution circulation device 500 in the crop cultivation system 10 according to the present disclosure.

FIG. 4 is a block diagram illustrating a configuration of a crop cultivation device 300 in the crop cultivation system 10 according to the present disclosure.

### MODES OF THE INVENTION

Hereinafter, embodiments of the present disclosure will be described in detail with reference to the accompanying drawings. However, even for components essential in carrying out the present disclosure, detailed description will be omitted if the components are introduced in the related art, or the components are matters that can easily be carried out based on the known art by those of ordinary skill in the art.

In addition, in the components belonging to the present disclosure, the term “device” or “unit” contained in the names refers to a unit for processing at least one common function or operation, and the unit may be implemented by hardware, software, or a combination thereof.

A crop cultivation system 10 for a ship according to the present disclosure may be installed in a large ship such as a trading ship, a cargo ship, a container carrier, an oil tanker, a deep-sea fishing vessel, an aircraft carrier, a passenger ship, or a cruise ship and may cultivate and harvest crops during an operation period of the ship.

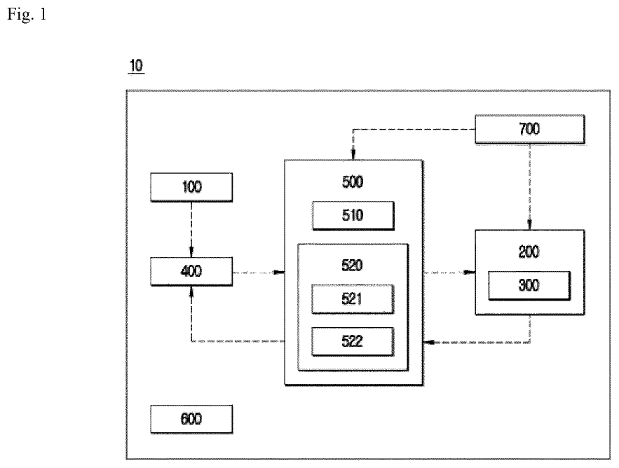

As shown in FIG. 1, the crop cultivation system 10 for a ship of the present disclosure is configured to include a freshwater supply device 100 providing freshwater needed for growth of crops, a crop cultivation house 200 providing a crop cultivation space, a crop cultivation device 300 provided in the crop cultivation house 200 and providing a means needed for sowing and growth of the crops, a nutrient solution production device 400 producing a nutrient solution needed for the growth of the crops using the freshwater, a nutrient solution circulation device 500 circulating the nutrient solution between the crop cultivation device 300 and the nutrient solution production device 400, and a control device 600 controlling operations of each of the components included in the crop cultivation system 10, and additionally, the crop cultivation system 10 may further include a gas supply device 700 configured to supply a gas to the crop cultivation device 300 and the nutrient solution circulation device 500.

First, the freshwater supply device 100 may acquire freshwater needed for growth of crops and may supply the freshwater to the nutrient solution production device 400. For example, when a ship in which the crop cultivation system 10 is installed operates on a river or lake, freshwater may be directly acquired from the river or lake, and when the ship sails on the sea, freshwater may be acquired from seawater using separate desalination equipment.

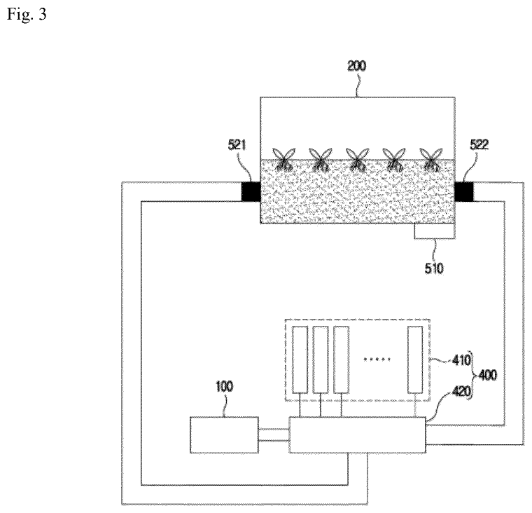

Referring to FIG. 3, the nutrient solution production device 400 may receive the freshwater from the freshwater supply device 100 and then may use the freshwater to produce a nutrient solution required for growth of crops. The nutrient solution production device 400 may include a plurality of element solution cartridges 410 each storing an element solution containing a predetermined element among elements needed for cultivating the crops and a nutrient solution production part 420 selecting at least any one of the element solution cartridges 410 and diluting the element solution stored therein together with the freshwater received from the freshwater supply device 100 to produce a nutrient solution.

Various elements, in addition to carbon dioxide, water, and sunlight, are required for growth of crops, and roots of crops absorb components of such elements. Generally, it is known that a total of 22 elements, that is, 9 bulk elements, 7 trace elements, and 6 other elements, are needed as elements involved in crop growth. Among these, bulk elements such as carbon (C), oxygen (O), and hydrogen (H) may be sufficiently supplied from air and water, and thus it may be preferable that other elements be included in the element solution embedded in the element solution cartridge 410.

More specifically, an element solution selectively including nitrogen (N), phosphorus (P), and potassium (K) that correspond to primary bulk elements, calcium (Ca), magnesium (Mg), and sulfur(S) that correspond to secondary bulk elements (required in smaller amounts than the primary bulk elements), 7 trace elements, and 6 other elements may be embedded in the element solution cartridge 410.

The nutrient solution production part 420 may select a specific element solution cartridge among the plurality of element solution cartridges 410 according to the type of cultivated crop and may produce a nutrient solution. For example, when a crop cultivated in the crop cultivation house 200 is a crop that can be harvested without a reproductive growth step, a nutrient solution may be produced after selecting first to third element solution cartridges each having one of the primary bulk elements embedded therein and fourth to sixth element solution cartridges each having one of the secondary bulk elements embedded therein.

In addition, when a crop cultivated in the crop cultivation house 200 is a crop that needs harvesting of flowers or fruits and thus needs quality management of reproductive growth as well as vegetative growth, a nutrient solution may be produced after selecting the first to third element solution cartridges each having one of the primary bulk elements embedded therein, the fourth to sixth element solution cartridges each having one of the secondary bulk elements embedded therein, seventh to thirteenth element solution cartridges each having one of the 7 trace elements embedded therein, and fourteenth to nineteenth element solution cartridges each having one of the 6 other elements embedded therein.

Korean Patent Registration No. 10-2479883 (Date of Registration: December 16, 2022) of the inventor of the present disclosure may be referenced for the nutrient solution production device 400.

The nutrient solution circulation device 500 serves to circulate a nutrient solution between the crop cultivation device 300 and the nutrient solution production device 400. The nutrient solution circulation device 500 may include a nutrient solution amount measurement part 510 measuring an amount of a nutrient solution present in the crop cultivation house 200.

The nutrient solution amount measurement part 510 may include a weight detection sensor provided on a bottom surface of the crop cultivation device 300 and may calculate the amount of nutrient solution of the crop cultivation device 300 based on a weight measured by the weight detection sensor.

In addition, the nutrient solution amount measurement part 510 may include a humidity level measurement sensor measuring a humidity level in the crop cultivation house 200 or a density measurement sensor measuring a density of the nutrient solution in a mist form inside the crop cultivation house 200 and may calculate the amount of nutrient solution of the crop cultivation device 300 based on the measured values.

When the weight of the nutrient solution on the bottom surface of the crop cultivation device 300 exceeds a reference value, the humidity level in the crop cultivation house 200 exceeds a reference value, or the density of the nutrient solution present in the crop cultivation house 200 exceeds a reference value, the nutrient solution amount measurement part 510 may deliver such a result to the control device 600, and the control device 600 may instruct a nutrient solution circulation part 520, which will be described below, to recover the nutrient solution.

In addition, the nutrient solution circulation device 500 may further include the nutrient solution circulation part 520 recovering the nutrient solution remaining after being absorbed into the crops in the crop cultivation device 300 to the nutrient solution production device 400 and re-supplying the nutrient solution produced in the nutrient solution production device 400 to the crop cultivation device 300.

The nutrient solution circulation part 520 may include a nutrient solution supply unit 521 directly spraying the nutrient solution produced in the nutrient solution production device 400 in a mist state to roots of crops planted in the crop cultivation device 300 and a nutrient solution recovery unit 522 recovering a nutrient solution remaining after being absorbed into the crops in the crop cultivation device 300 to the nutrient solution production device 400.

Here, the nutrient solution supply unit 521 may be configured to spray a nutrient solution in a mist form to roots of crops using vibrations caused by an ultrasonic vibration device or a centrifugal force caused by a plurality of rotary blades, and the nutrient solution recovery unit 522 may recover the nutrient solution in the mist form through an air flow generated due to a suctioning method or rotation of the plurality of rotary blades.

The crop cultivation system 10 for a ship according to the present disclosure may further include the gas supply device 700 supplying air to the crop cultivation house 200 and the nutrient solution circulation device 500. The gas supply device 700 may be configured to supply a gas into the crop cultivation house 200 to supply a gas needed for crop growth, such as oxygen and carbon dioxide.

In addition, the gas supply device 700 may supply a gas for the nutrient solution circulation device 500 to produce a nutrient solution in a mist form. At this time, the control device 600 may control operations of the nutrient solution circulation device 500 and the gas supply device 700 to adjust the density of the nutrient solution in the mist form that is supplied to the crop cultivation device 300.

Specifically, there is a need to adjust the density of the nutrient solution in the mist form for each growth and development step of a crop. In this case, the control device 600 may adjust the density of the nutrient solution by controlling the operations of the nutrient solution circulation part 520 and the gas supply device 700 and adjusting a mixing ratio between the nutrient solution and the gas.

The nutrient solution remaining after nutrients are supplied to the crops through the nutrient solution circulation device 500 may be recovered to the nutrient solution production device 400, and the nutrient solution production device 400 may reuse the recovered nutrient solution to produce the nutrient solution again and then may provide the nutrient solution to the crop cultivation house 200. In this process, the nutrient solution production device 400 may measure a concentration of each element included in the recovered nutrient solution and then may select only the element solution cartridge 410 having an element whose measured concentration is lower than a predetermined concentration embedded therein to replenish the insufficient element.

Meanwhile, preferably, the crop cultivation house 200 may be configured as an air house made of a flexible material such as a double wall fabric or an air tube. A crop cultivation space may be formed in the air house constituting the crop cultivation house 200 by injecting compressed air from the gas supply device 700.

When an air house is used as the crop cultivation house 200, there are advantages in that delivery, installation, removal, and movement are easy, and a burden caused by weight can be relieved. Such an air house is specified in Korean Patent Registration No. 10-2565560 (Date of Registration: Aug. 7, 2023) of the inventor of the present disclosure and PCT/KR 2023/007505 (Jun. 1, 2023) corresponding thereto.

The crop cultivation device 300 may be provided inside the crop cultivation house 200. When an air house is provided as the crop cultivation house 200, the frame of the crop cultivation device 300 may also be configured using a double wall fabric or an air tube like the air house.

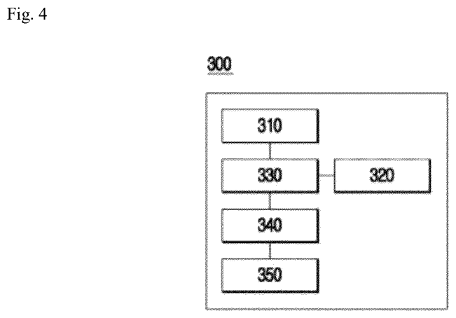

In addition, as illustrated in FIG. 4, the crop cultivation device 300 may include a sowing part 310 sowing seeds of crops to be cultivated, a management part 320 configured to manage a cultivation process of the crops by monitoring and controlling at least any one of a temperature, a humidity level, and a quantity of light in the cultivation process of the crops, a harvesting part 330 configured to harvest the crops that have grown completely, a processing part 340 configured to process the harvested crops by refrigerating, freezing, drying, or salting them, and a storage part 350 configured to store the processed crops and monitor a stored amount of each crop. However, in some cases, the storage part 350 may be separately provided in another space instead of being provided inside the crop cultivation house 200.

The crop cultivation device 300 may be automatically operated according to a predetermined program without any artificial manipulation by humans. To this end, the control device 600 may further include a crop-to-be-sown selection part (not illustrated) configured to select a crop to be sown through the sowing part 310 and generate crop-to-be-sown selection data. In this case, the sowing part 310 may sow a seed based on the crop-to-be-sown selection data received from the control device 600.

The crop-to-be-sown selection part may select a crop to be sown in consideration of the following matters and then may generate the crop-to-be-sown selection data. In addition, the crop-to-be-sown selection part may be configured to generate an order of priority of crops in demand at a destination of the ship and select a crop to be sown based on the generated crop demand.

For example, when a transportation means departs from port a of continent A and is set to arrive at port b of continent B, the crop-to-be-sown selection part may generate an order of crops in need for each crop at port b of continent B. At this time, the crop-to-be-sown selection part may generate the order of crops in need in order of crops with highest to lowest average transaction price during a predetermined period for crops traded in a market most adjacent to port b of continent B and may select the crop that comes first in the order of crops in need and may control the selected crop to be sown through the sowing part 310.

In addition, the crop-to-be-sown selection part may be configured to select a crop to be sown in consideration of an operation path and an operation period of a transportation means and a growth period and growth conditions of a crop. For example, the crop-to-be-sown selection part may select a crop with growth conditions suitable for an environment, such as a temperature, along an operation path and in which an error between an operation period and n times a growth period of the crop (n is a natural number of 1 or greater) is less than a predetermined reference value and may control the crop selected through such a process to be sown through the sowing part 310.

In addition, the crop-to-be-sown selection part may be configured to select a crop to be sown based on whether a stored amount of each crop stored in the storage part 350 satisfies a predetermined stored amount. For example, when a stored amount of a second crop does not satisfy a predetermined stored amount while a stored amount of a first crop satisfies the predetermined stored amount in a long-distance operation process, the crop-to-be-sown selection part may control a seed of the second crop to be sown through the sowing part 310.

In addition, the crop-to-be-sown selection part may divide an area in which sowing is possible in the crop cultivation device 300 into a plurality of sections and then may control different crops to be sown in each section through the sowing part 310. For example, when crops to be sown are selected based on crop demand at a destination of the ship and are sown through the sowing part 310, a first-priority crop may be sown in a first area among the plurality of sections, a second-priority crop may be sown in a second area, and at this time, the first area may be an area wider than the second area.

Although the present disclosure has been described above using embodiments, the above embodiments are only for describing the spirit of the present disclosure, and the present disclosure is not limited thereto. Those of ordinary skill in the art should understand that various modifications may be made to the embodiments described above. The scope of the present disclosure should be defined only through interpretation of the appended claims.

### DESCRIPTION OF REFERENCE NUMERALS

10 crop cultivation system for ship 100 freshwater supply device
200 crop cultivation house 300 crop cultivation device
310 sowing part 320 management part
330 harvesting part 340 processing part
350 storage part 400 nutrient solution production device
410 element solution cartridge 420 nutrient solution production part
500 nutrient solution circulation device 510 nutrient solution amount measurement part
520 nutrient solution circulation part 521 nutrient solution supply unit
522 nutrient solution recovery unit 600 control device
700 gas supply device

1. A crop cultivation system for a ship that is configured to cultivate and harvest crops inside a ship during an operation period of the ship, the crop cultivation system comprising:
a freshwater supply device providing freshwater needed for growth of the crops;
a crop cultivation house installed inside the ship and providing a crop cultivation space;
a crop cultivation device installed inside the crop cultivation house and providing a means needed for sowing and growth of the crops;
a nutrient solution production device producing a nutrient solution by mixing a nutrient needed for growth of the crops into the freshwater;
a nutrient solution circulation device supplying the nutrient solution to the crop cultivation device and recovering the remaining nutrient solution to the nutrient solution production device; and
a control device controlling operations of the components constituting the crop cultivation system.

2. The crop cultivation system of claim 1, wherein the freshwater supply device is configured to include a freshwater acquisition part acquiring freshwater from seawater and a freshwater supply part supplying the freshwater to the crop cultivation device.

3. The crop cultivation system of claim 1, wherein the crop cultivation house is configured as an air house having a crop cultivation space by injecting compressed air into a double wall fabric or an air tube made of a flexible material.

4. The crop cultivation system of claim 1, wherein the nutrient solution production device is configured to include a plurality of element solution cartridges each storing an element solution containing a predetermined element among elements needed for cultivating the crops and a nutrient solution production part selecting at least any one of the element solution cartridges according to a crop type and diluting the element solution stored therein together with the freshwater provided from the freshwater supply device to produce the nutrient solution.

5. The crop cultivation system of claim 1, wherein the nutrient solution circulation device includes a nutrient solution supply unit directly spraying the nutrient solution produced by the nutrient solution production device in a mist state to roots of crops planted in the crop cultivation device and a nutrient solution recovery unit recovering the nutrient solution remaining after being absorbed into the crops in the crop cultivation device to the nutrient solution production device.

6. The crop cultivation system of claim 5, wherein air is supplied to the nutrient solution circulation device through a gas supply device, and the control device controls operations of the nutrient solution circulation device and the gas supply device to adjust a mist density of the nutrient solution supplied to the crop cultivation device.

7. The crop cultivation system of claim 1, wherein:
the control device includes a crop-to-be-sown selection part selecting a crop to be sown in the crop cultivation device in consideration of an operation path and an operation period of the ship, a growth period and growth conditions of a crop, and crop demand at a destination of the ship; and
the crop cultivation device includes a sowing part sowing a seed based on crop-to-be-sown selection data provided by the crop-to-be-sown selection part.
